(19) United States
(12) Patent Application Publication
(10) Pub. No.: US 2020/0131961 A1
(43) Pub. Date: Apr. 30, 2020

(54) EXHAUST GAS TREATMENT SYSTEMS AND METHODS FOR DIAGNOSING THE SAME

(71) Applicant: GM GLOBAL TECHNOLOGY OPERATIONS LLC, DETROIT, MI (US)

(72) Inventors: Shouxian Ren, Rochester Hills, MI (US); Raffaele Esposito, Torino (IT); Gongshin Qi, Troy, MI (US); Wei Li, Troy, MI (US); Giovanni Montinaro, Torino (IT); Francesco Irlando, Turin (IT)

(21) Appl. No.: 16/173,679

(22) Filed: Oct. 29, 2018

(51) Int. Cl. F01N 3/20; B01D 53/94; F01N 11/00

(52) U.S. Cl. CPC F01N 3/208; B01D 53/9418; B01D 53/9495; F01N 3/2073; F01N 2550/02; B01D 53/9481; F01N 11/007; F01N 2900/0416; F01N 2900/1614; B01D 53/944

(57) ABSTRACT

Provided are methods for diagnosing a selective catalytic reduction device (SCR) of an exhaust gas treatment system, wherein the system includes an engine, an ammonia-generating catalytic device (AGC) configured to receive exhaust gas generated by the engine and capable of generating ammonia from rich exhaust gas, the SCR configured to receive exhaust gas and ammonia generated by the AGC, an upstream NOx sensor disposed upstream from the SCR, and a downstream NOx sensor disposed downstream from the SCR. The method includes increasing the temperature of the SCR to substantially empty all reductant stored within the SCR, during a diagnostic period, maintaining a rich engine operating condition and communicating the generated exhaust gas to the AGC and the SCR, determining a SCR reductant storage capacity based on measurements taken by the downstream NOx sensor during the diagnostic period, and optionally implementing a control action based on the determined storage capacity.

### BACKGROUND

Exhaust gas emitted from an internal combustion engine is a heterogeneous mixture that contains gaseous emissions such as carbon monoxide (“CO”), unburned hydrocarbons (“HC”) and oxides of nitrogen (“NOx”) as well as condensed phase materials (liquids and solids) that constitute particulate matter (“PM”). Catalyst compositions, typically disposed on catalyst supports or substrates, are provided in an engine exhaust system as part of an aftertreatment system to convert certain or all of these exhaust constituents.

Exhaust gas treatment systems, such as those appurtenant to diesel engines, typically include selective catalytic reduction devices (SCR). An SCR includes a substrate having an SCR catalyst disposed thereon to reduce the amount of NOx in the exhaust gas. The typical exhaust treatment system also includes a reductant delivery system that injects a reductant such as, for example, ammonia (NH3), urea (CO(NH2)2, etc.). The SCR makes use of NH3 to reduce the NOx. For example, when the proper amount of NH3 is supplied to the SCR under the proper conditions, the NH3 reacts with the NOx in the presence of the SCR catalyst to reduce the NOx emissions. If the reduction reaction rate is too slow, or if there is excess ammonia in the exhaust, ammonia can slip from the SCR. On the other hand, if there is too little ammonia in the exhaust, SCR NOx conversion efficiency will be decreased.

The reductant storage capacity of the SCR 220 critically impacts the NOx reduction efficiency and performance thereof. Because NOx sensors are cross sensitive to NOx and NH3, methods for directly measuring SCR 220 storage capacity (e.g., diagnosing a SCR monolith) are not available.

### SUMMARY

Provided are exhaust gas treatment systems which include an internal combustion engine (ICE), an ammonia-generating catalytic device (AGC) configured to receive exhaust gas generated by the ICE and capable of generating ammonia from rich exhaust gas, a selective catalytic reduction device (SCR) configured to receive exhaust gas and ammonia generated by the AGC, an upstream NOx sensor disposed upstream from the SCR, a downstream NOx sensor disposed downstream from the SCR, and a controller. The controller is configured to increase the temperature of the SCR to substantially empty all reductant stored within the SCR, maintain a rich ICE operating condition, and subsequently determine a SCR reductant storage capacity using the downstream NOx sensor. The AGC can be a diesel oxidation catalyst or a lean NOX trap. The AGC can include a platinum and/or palladium catalyst. During the rich ICE operating condition the ICE air to fuel mass ratio can be less than about 14.7. The controller can be configured to increase the temperature of the SCR by increasing the temperature of the exhaust gas generated by the ICE, and/or utilizing a heater appurtenant to the exhaust gas treatment system. The controller can be further configured to determine unsuitable SCR performance prior to increasing the temperature of the SCR. Unsuitable performance can be unsuitable NOx reduction efficiency, and/or unsuitable NOx slip. The controller can be further configured to implement a control action based on the determined SCR reductant storage capacity. If the determined SCR reductant storage capacity is below a target capacity, the control action can include one or more of activating an alarm, servicing the SCR, and updating SCR control logic to reflect a reduced SCR storage capacity. If the determined SCR reductant storage capacity is at or above a target capacity, the control action can include implementing a non-SCR diagnostic action.

Provided are methods for diagnosing a selective catalytic reduction device (SCR) of an exhaust gas treatment system. The exhaust gas treatment system can include an internal combustion engine (ICE), an ammonia-generating catalytic device (AGC) configured to receive exhaust gas generated by the ICE and capable of generating ammonia from rich exhaust gas, the SCR configured to receive exhaust gas and ammonia generated by the AGC, an upstream NOx sensor disposed upstream from the SCR, and a downstream NOx sensor disposed downstream from the SCR. The method can include increasing the temperature of the SCR to substantially empty all reductant stored within the SCR, during a diagnostic period, maintaining a rich ICE operating condition and communicating the generated exhaust gas to the AGC and the SCR, and determining a SCR reductant storage capacity based on measurements taken by the downstream NOx sensor during the diagnostic period. The AGC can be a diesel oxidation catalyst or a lean NOX trap. The AGC can be a platinum and/or palladium catalyst. During the rich ICE operating condition the ICE air to fuel mass ratio can be less than about 14.7. The temperature of the SCR can be increased by increasing the temperature of the exhaust gas generated by the ICE, and/or utilizing a heater appurtenant to the exhaust gas treatment system. The method can further include determining unsuitable SCR performance prior to increasing the temperature of the SCR. Unsuitable performance can be unsuitable NOx reduction efficiency, and/or unsuitable NOx slip. The method can further include implementing a control action based on the determined SCR reductant storage capacity. If the determined SCR reductant storage capacity is below a target capacity, the control action can include one or more of activating an alarm, servicing the SCR, and updating SCR control logic to reflect a reduced SCR storage capacity. If the determined SCR reductant storage capacity is at or above a target capacity, the control action can include implementing a non-SCR diagnostic action.

The above features and advantages, and other features and advantages of the disclosure are readily apparent from the following detailed description when taken in connection with the accompanying drawings.

### BRIEF DESCRIPTION OF THE DRAWINGS

FIG. 1 illustrates a motor vehicle including an internal combustion engine and an emission control system, according to one or more embodiments;

FIG. 2 illustrates example components of an exhaust gas treatment system, according to one or more embodiments;

FIG. 3 illustrates a block diagram of a method for diagnosing exhaust gas treatment systems, according to one or more embodiments; and

FIG. 4 illustrates a graph of NH3 and NO concentrations of exhaust gas at a DOC outlet, according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

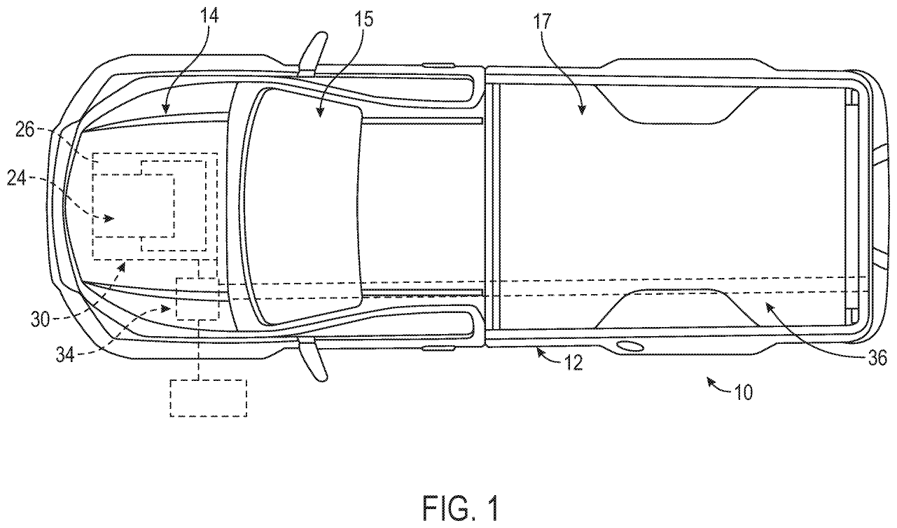

A motor vehicle, in accordance with an aspect of an exemplary embodiment, is indicated generally at 10 in FIG. 1. Motor vehicle 10 is shown in the form of a pickup truck. It is to be understood that motor vehicle 10 may take on various forms including automobiles, commercial transports, marine vehicles, and the like. Motor vehicle 10 includes a body 12 having an engine compartment 14, and optionally a passenger compartment 15 and/or a cargo bed 17. Engine compartment 14 houses a diesel internal combustion engine (ICE) system 24. ICE system 24 includes an exhaust system 30 that is fluidically connected to an aftertreatment or exhaust gas treatment system 34. Exhaust produced by ICE system 24 passes through exhaust gas treatment system 34 to reduce and/or convert emissions that may exit to ambient through an exhaust outlet pipe 36.

The technical solutions described herein are germane to ICE systems that can include, but are not limited to, diesel engine systems. The ICE system 24 can include a plurality of reciprocating pistons attached to a crankshaft, which may be operably attached to a driveline, such as a vehicle driveline, to power a vehicle (e.g., deliver tractive torque to the driveline). For example, the ICE system 24 can be any engine configuration or application, including various vehicular applications (e.g., automotive, marine and the like), as well as various non-vehicular applications (e.g., pumps, generators and the like). While the ICEs may be described in a vehicular context (e.g., generating torque), other non-vehicular applications are within the scope of this disclosure. Therefore, when reference is made to a vehicle, such disclosure should be interpreted as applicable to any application of an ICE system.

Moreover, an ICE can generally represent any device capable of generating an exhaust gas stream comprising gaseous (e.g., NOx, O2), carbonaceous, and/or particulate matter species, and the disclosure herein should accordingly be interpreted as applicable to all such devices. As used herein, “exhaust gas” refers to any chemical species or mixture of chemical species which may require treatment, and includes gaseous, liquid, and solid species. For example, an exhaust gas stream may contain a mixture of one or more NOx species, one or more liquid hydrocarbon species, and one more solid particulate species (e.g., ash). It should be further understood that the embodiments disclosed herein may be applicable to treatment of effluent streams not comprising carbonaceous and/or particulate matter species, and, in such instances, ICE 26 can also generally represent any device capable of generating an effluent stream comprising such species. Exhaust gas particulate matter generally includes carbonaceous soot, and other solid and/or liquid carbon-containing species which are germane to ICE exhaust gas or form within an exhaust gas treatment system 34.

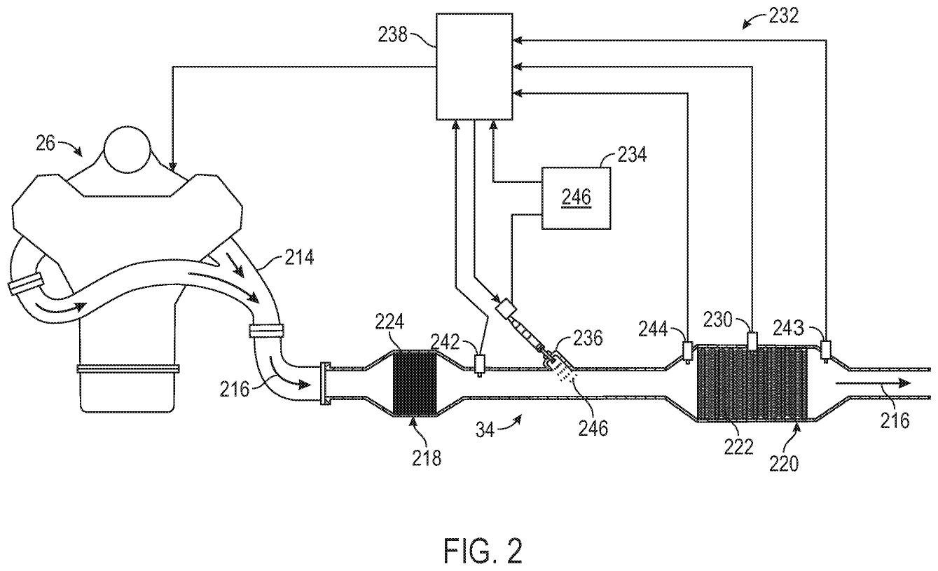

FIG. 2 illustrates example components of the exhaust gas treatment system 34 according to one or more embodiments. The exhaust gas treatment system 34 facilitates the control and monitoring of NOx storage and/or treatment materials, to control exhaust produced by the ICE system 24. For example, the technical solutions herein provide methods for controlling selective catalytic reduction devices (SCR), and appurtenant NOx sensors, wherein the SCRs are configured to receive exhaust gas streams from an exhaust gas source. As used herein, “NOx” refers to one or more nitrogen oxides. NOx species can include NyOx species, wherein y>0 and x>0. Non-limiting examples of nitrogen oxides can include NO, NO2, N2O, N2O2, N2O3, N2O4, and N2O5. SCRs are configured to receive reductant, such as at variable dosing rates as will be described below.

The exhaust gas conduit 214, which may comprise several segments, transports exhaust gas 216 from the ICE 26 to the various exhaust treatment devices of the exhaust gas treatment system 34. For example, as illustrated, the emission control system 34 includes a SCR 220. In one or more examples, the SCR 220 can include a selective catalytic filter (SCRF) device, which provides the catalytic aspects of an SCR in addition to particulate filtering capabilities. Additionally or alternatively, the SCR catalyst can also be coated on a flow through substrate. As can be appreciated, system 34 can include various additional treatment devices, including an ammonia-generating catalytic device (AGC) 218, and particulate filter devices (not shown), among others.

The AGC 218 generally comprises a device which can convert NOx species to NH₃, particularly under rich-burn ICE operating conditions, as will be described below. An AGC 218 generally includes a catalyst, such as a platinum or palladium catalyst, disposed on a substrate 224 (e.g., a flow-through metal or ceramic monolith substrate) enclosed in a flow-through container. The substrate 224 may be packaged in a stainless steel shell or canister having an inlet and an outlet in fluid communication with the exhaust gas conduit 214. For example, the AGC 218 can be an oxidation catalyst device (OC), or a lean NOx trap (LNT), in some embodiments.

OCs are generally utilized to oxidize NO species to NO₂, under certain conditions, and unburned gaseous and non-volatile HC and CO to form carbon dioxide and water. An OC can be one of various flow-through, oxidation catalyst devices known in the art. The substrate 224 of an OC can include an oxidation catalyst compound disposed thereon. The oxidation catalyst compound may be applied to the substrate 224 as a washcoat, for example, and may contain platinum group metals such as platinum (Pt), palladium (Pd), rhodium (Rh) or other suitable oxidizing catalysts, or combination thereof. A washcoat layer includes a compositionally distinct layer of material disposed on the surface of the monolithic substrate or an underlying washcoat layer. A catalyst can contain one or more washcoat layers, and each washcoat layer can have unique chemical catalytic functions.

LNTs are generally utilized to store NOx at temperatures lower than the temperatures at which the SCR 220 is catalytically active and/or capable of storing NOx, for example. For example, LNTs are generally suitable for storing NOx at temperatures below about 300° C. In lean conditions (i.e., wherein the air to fuel ratio exceeds stoichiometric demands), a LNT can operate as an oxidation catalyst for hydrocarbons and CO, and as a trap (i.e., absorber) to store NON. During rich combustion conditions (i.e., wherein the air to fuel ratio is below stoichiometric demands) NOx in the exhaust gas 216 or stored within the LNT are reduced, as will be described below. A LNT can be one of various flow-through devices known in the art, wherein the substrate 224 can be impregnated, for example, with various materials including catalysts (e.g., platinum, palladium, and/or rhodium catalysts), base metal oxides (e.g., barium oxides), and barium salts, among others.

The SCR 220 may be disposed downstream from the AGC 218. In one or more examples, the SCR 220 includes a filter portion 222 that can be a wall flow filter that is configured to filter or trap carbon and other particulate matter from the exhaust gas 216. In at least one exemplary embodiment, the filter portion 222 is formed as a particulate filter (PF), such as a diesel particulate filter (DPF). The filter portion (i.e., the PF) may be constructed, for example, using a ceramic wall flow monolith exhaust gas filter substrate, which is packaged in a rigid, heat resistant shell or canister. The filter portion 222 has an inlet and an outlet in fluid communication with exhaust gas conduit 214 and may trap particulate matter as the exhaust gas 216 flows therethrough. It is appreciated that a ceramic wall flow monolith filter substrate is merely exemplary in nature and that the filter portion 222 may include other filter devices such as wound or packed fiber filters, open cell foams, sintered metal fibers, etc. The exhaust gas treatment system 34 may also perform a regeneration process that regenerates the filter portion 222 by burning off the particulate matter trapped in the filter substrate, in one or more examples.

In one or more examples, the SCR 220 receives reductant, such as at variable dosing rates. Reductant 246 can be supplied from a reductant supply source 234. In one or more examples, the reductant 246 is injected into the exhaust gas conduit 214 at a location upstream of the SCR 220 using an injector 236, or other suitable method of delivery. The reductant 246 can be in the form of a gas, a liquid, or an aqueous solution, such as an aqueous urea solution. In one or more examples, the reductant 246 can be mixed with air in the injector 236 to aid in the dispersion of the injected spray. The catalyst containing washcoat disposed on the filter portion 222 or a flow through catalyst or a wall flow filter may reduce NOx constituents in the exhaust gas 216. The SCR 220 utilizes the reductant 246, such as ammonia (NH3), to reduce the NOx. The catalyst containing washcoat may contain a zeolite and one or more base metal components such as iron (Fe), cobalt (Co), copper (Cu), or vanadium (V), which can operate efficiently to convert NOx constituents of the exhaust gas 216 in the presence of NH3. In one or more examples, a turbulator (i.e., mixer) (not shown) can also be disposed within the exhaust conduit 214 in close proximity to the injector 236 and/or the SCR 220 to further assist in thorough mixing of reductant 246 with the exhaust gas 216 and/or even distribution throughout the SCR 220.

The exhaust gas treatment system 34 further includes a reductant delivery system 232 that introduces the reductant 246 to the exhaust gas 216. The reductant delivery system 232 includes the reductant supply 234 and the injector 236. The reductant supply 234 stores the reductant 246 and is in fluid communication with the injector 236. The reductant 246 may include, but is not limited to, NH3. Accordingly, the injector 236 may inject a selectable amount of reductant 246 into the exhaust gas conduit 214 such that the reductant 246 is introduced to the exhaust gas 216 at a location upstream of the SCR 220.

In one or more examples, the exhaust gas treatment system 34 further includes a control module 238 operably connected, via a number of sensors, to monitor the ICE 26 and/or the exhaust gas treatment system 34. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. For example, module 238 can execute a SCR chemical model, as described below. The control module 238 can be operably connected to ICE system 24, SCR 220, and/or one or more sensors. As shown, the sensors can include an upstream NOx sensor 242, disposed between the AGC 218 and the SCR 220, and downstream NOx sensor 243, disposed downstream of SCR 220, each of which are in fluid communication with exhaust gas conduit 214. In one or more examples, the upstream NOx sensor 242 is disposed downstream of the ICE 26 and upstream of both SCR 220 and the injector 236. The upstream NOx sensor 242 and the downstream NOx sensor 243 detect a NOx level proximate their location within exhaust gas conduit 214, and generate a NOx signal, which corresponds to the NOx level. A NOx level can comprise a concentration, a mass flow rate, or a volumetric flow rate, in some embodiments. A NOx signal generated by a NOx sensor can be interpreted by control module 238, for example. Control module 238 can optionally be in communication one or more temperature sensors, such as upstream temperature sensor 244, disposed upstream from SCR 220, or SCR temperature sensor 230 disposed contiguous with or within SCR 220.

In one or more examples, the SCR 220 includes one or more components that utilize the reductant 246 and a catalyst to transform NO and NO₂ from the exhaust gases 216. The SCR 220 can include, for example, a flow-through ceramic or metal monolith substrate that can be packaged in a shell or canister having an inlet and an outlet in fluid communication with the exhaust gas conduit 214 and optionally other exhaust treatment devices. The shell or canister can ideally comprise a substantially inert material, relative to the exhaust gas constituents, such as stainless steel. The substrate can include a SCR catalyst composition applied thereto.

The substrate body can, for example, be a ceramic brick, a plate structure, or any other suitable structure such as a monolithic honeycomb structure that includes several hundred to several thousand parallel flow-through cells per square inch, although other configurations are suitable. Each of the flow-through cells can be defined by a wall surface on which the SCR catalyst composition can be washcoated. The substrate body can be formed from a material capable of withstanding the temperatures and chemical environment associated with the exhaust gas 216. Some specific examples of materials that can be used include ceramics such as extruded cordierite, α-alumina, silicon carbide, silicon nitride, zirconia, mullite, spodumene, alumina-silica-magnesia, zirconium silicate, sillimanite, petalite, or a heat and corrosion resistant metal such as titanium or stainless steel. The substrate can comprise a non-sulfating TiO2 material, for example. The substrate body can be a PF device, as will be discussed below.

The SCR catalyst composition is generally a porous and high surface area material which can operate efficiently to convert NOx constituents in the exhaust gas 216 in the presence of a reductant 246, such as ammonia. For example, the catalyst composition can contain a zeolite impregnated with one or more base metal components such as iron (Fe), cobalt (Co), copper (Cu), vanadium (V), sodium (Na), barium (Ba), titanium (Ti), tungsten (W), and combinations thereof In a particular embodiment, the catalyst composition can contain a zeolite impregnated with one or more of copper, iron, or vanadium. In some embodiments the zeolite can be a β-type zeolite, a Y-type zeolite, a ZM5 zeolite, or any other crystalline zeolite structure such as a Chabazite or a USY (ultra-stable Y-type) zeolite. In a particular embodiment, the zeolite comprises Chabazite. In a particular embodiment, the zeolite comprises SSZ. Suitable SCR catalyst compositions can have high thermal structural stability, particularly when used in tandem with particulate filter (PF) devices or when incorporated into SCRF devices, which are regenerated via high temperature exhaust soot burning techniques.

The SCR catalyst composition can optionally further comprise one or more base metal oxides as promoters to further decrease the SO₃ formation and to extend catalyst life. The one or more base metal oxides can include WO₃, Al2O₃, and MoO₃, in some embodiments. In one embodiment, WO₃, Al₂O₃, and MoO₃ can be used in combination with V₂O₅.

The SCR catalyst generally uses the reductant 246 to reduce NOx species (e.g., NO and NO2) to harmless components. Harmless components include one or more of species which are not NOx species, such as diatomic nitrogen, nitrogen-containing inert species, or species which are considered acceptable emissions, for example. The reductant 246 can be NH₃, such as anhydrous ammonia or aqueous ammonia, or generated from a nitrogen and hydrogen rich substance such as urea (CO(NH₂)₂). Additionally or alternatively, the reductant 246 can be any compound capable of decomposing or reacting in the presence of exhaust gas 216 and/or heat to form ammonia. Equations (1)-(5) provide exemplary chemical reactions for NOx reduction involving ammonia.

6NO+4NH3→5N2+6H2O (1)

4NO+4NH3+O2→4N2+6H2O (2)

6NO2+8NH3→7N2+12H2O (3)

2NO2+4NH3+O2→3N2+6H2O (4)

NO+NO2+2NH3→2N2+3H2O (5)

It should be appreciated that Equations (1)-(5) are merely illustrative, and are not meant to confine the SCR 220 to a particular NOx reduction mechanism or mechanisms, nor preclude the operation of other mechanisms. The SCR 220 can be configured to perform any one of the above NOx reduction reactions, combinations of the above NOx reduction reactions, and other NOx reduction reactions.

The reductant 246 can be diluted with water in various implementations. In implementations where the reductant 246 is diluted with water, heat (e.g., from the exhaust) evaporates the water, and ammonia is supplied to the SCR 220. Non-ammonia reductants can be used as a full or partial alternative to ammonia as desired. In implementations where the reductant 246 includes urea, the urea reacts with the exhaust to produce ammonia, and ammonia is supplied to the SCR 220. Equation (6) below provides an exemplary chemical reaction of ammonia production via urea decomposition.

CO(NH2)2+H2O→2NH3+CO2 (6)

It should be appreciated that Equation (6) is merely illustrative, and is not meant to confine the urea or other reductant 246 decomposition to a particular single mechanism, nor preclude the operation of other mechanisms.

The SCR catalyst can store (i.e., absorb, and/or adsorb) reductant for interaction with exhaust gas 216. For example, the reductant 246 can be stored within the SCR 220 or catalyst as ammonia. A given SCR 220 has a reductant capacity, or “storage capacity”—the amount of reductant or reductant derivative it is capable of storing. The amount of reductant stored within an SCR 220 relative to the SCR catalyst capacity can be referred to as the SCR “reductant loading”/“NH3 storage level”, and can be indicated as a % loading (e.g., 90% reductant loading) in some instances. During operation of SCR 220, injected reductant 246 is stored in the SCR catalyst and consumed during reduction reactions with NOx species and must be continually replenished. Determining the precise amount of reductant 246 to inject is critical to maintaining exhaust gas emissions at acceptable levels: insufficient reductant levels within the system 34 (e.g., within SCR 220) can result in undesirable NOx species emissions (“NOx breakthrough”) from the system (e.g., via a vehicle tailpipe), while excessive reductant 246 injection can result in undesirable amounts of reductant 246 passing through the SCR 220 unreacted or exiting the SCR 220 as an undesired reaction product (“reductant slip”). Reductant slip and NOx breakthrough can also occur when the SCR catalyst is below a “light-off” temperature, for example if the SCR 220 is saturated with NH3 (i.e. no more storage sites).

SCR dosing logic can be utilized to command reductant 246 dosing, and adaptations thereof, and can be implemented by module 238. For example, the control module 238 can control operation of the injector 236 based on a chemical model and a desired reductant (e.g., NH3) storage set point to determine an amount of reductant 246 to be injected as described herein. A reductant injection dosing rate (e.g., grams per second) can be determined by a SCR chemical model which predicts an NH3 storage level of the SCR 220 based on signals from one or more of reductant 246 injection (e.g., feedback from injector 236) and upstream NOx (e.g., NOx signal from upstream NOx sensor 242). The SCR chemical model further predicts NOx levels of exhaust gas 216 discharged from the SCR 220. The SCR chemical model, and the strategies and methods described below, can be implemented by control module 238, or alternatively by one or more electric circuits, or by the execution of logic that may be provided or stored in the form of computer readable and/or executable instructions. The SCR chemical model can be updatable by one or more process values over time, for example.

The reductant storage capacity of the SCR 220 critically impacts the NOx reduction efficiency and performance thereof. Accordingly, provided herein are methods for diagnosing the storage capacity of SCR 220. More generally, the methods described herein are suitable for diagnosing several aspects of an exhaust gas treatment system 34, as will be described below. The methods and systems will be described in reference to the exhaust gas treatment system 34 of FIG. 1, but the methods are not intended to be limited to the particular characteristics thereof. The methods as described below necessarily also describe control modules (e.g., control module 238) and appurtenant systems (e.g., exhaust gas treatment system 34) configured to implement the described methods.

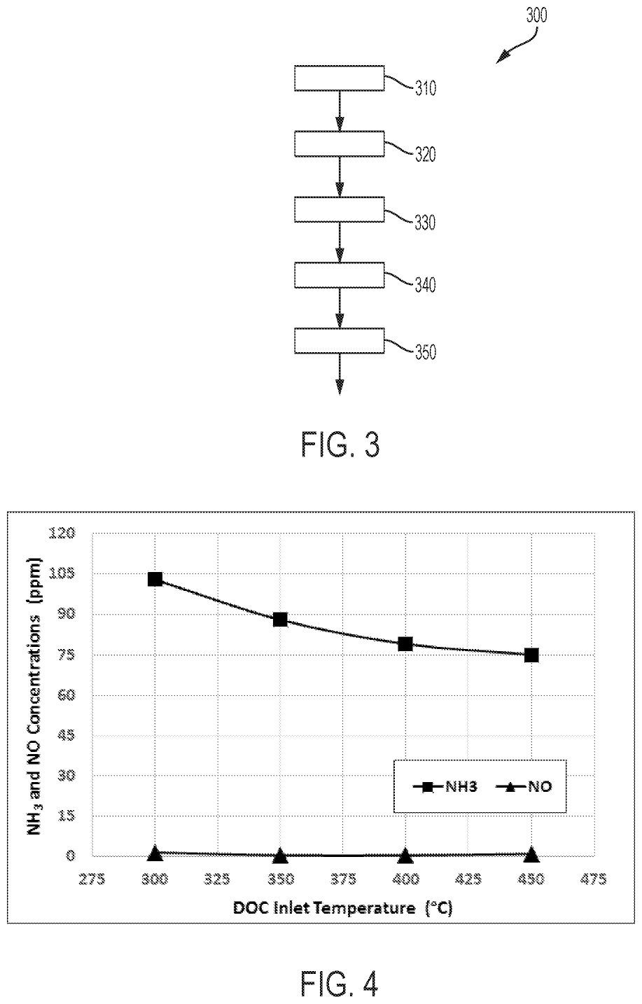

FIG. 3 illustrates a block diagram of a method 300 for diagnosing exhaust gas treatment system 34, and particularly SCR 220. Method 300 comprises increasing the temperature 320 of the SCR 220 to substantially empty all reductant 246 stored within the SCR 220, maintaining 330 a rich ICE 26 operating condition, and determining 340 a SCR 220 reductant 246 storage capacity based on measurements taken by the downstream NOx 243 sensor during the diagnostic period. Optionally, method 300 can comprise determining 310 unsuitable SCR 220 performance prior to increasing the temperature 320 of the SCR 220. Method 300 can further optionally comprise implementing 350 a control action based on the determined 340 SCR 220 reductant 246 storage capacity.

Determining 310 unsuitable performance of the SCR 220 can comprise determining 310 unsuitable SCR 220 NOx reduction efficiency, and/or determining 310 unsuitable SCR 220 NOx slip, for example. Unsuitable SCR 220 NOx slip can be determined when a measured NOx content of exhaust gas 216 downstream from the SCR 220 exceeds a threshold. Similarly, unsuitable NOx reduction efficiency can be determined 310 when a measured NOx reduction efficiency falls below a reference or threshold NOx reduction efficiency. In one embodiment, measured NOx reduction efficiency can be determined by equation (7):

$${η}_{Measured} = 1 - \frac{\int {NOx}_{Downstream}}{{NOx}_{Upstream}} \qquad ( 7 )$$

wherein NOx_{Downstream} is measured by the downstream NOx sensor 243 and NOx_{Upstream} is measured by the upstream NOx sensor 242. Similarly, the reference NOx reduction efficiency can be determined by equation (8):

$${η}_{Reference} = 1 - \frac{\int {NOx}_{Threshold}}{{NOx}_{Upstream}} \qquad ( 8 )$$

wherein NOx_{Upstream} is measured by the upstream NOx sensor 242, and NOx_{Threshold} is determined based on factors such as NOx_{Upstream}, exhaust gas 216 flow, SCR 220 temperature (e.g., as measured by upstream temperature sensor 244 or SCR temperature sensor 230) and the SCR 220 reductant 246 loading.

Accordingly, if unsuitable performance of the SCR 220 is determined 310, method 300 can proceed to diagnose the storage capacity of the SCR 220. The successive diagnosis can generally occur during a diagnostic period which can begin while increasing the temperature 320 of the SCR 220 to substantially empty all reductant 246 stored within the SCR 220, or begin once all reductant stored within the SCR 220 has been substantially emptied. Generally, an SCR 220 must be heated from about 300° C. to about 500° C. in order to substantially empty all stored reductant 246, but the exact temperatures will depend on the features of a specific SCR 220. During the diagnostic period, reductant 246 dosing (e.g., via injector 236) does not occur. Methods for increasing the temperature 320 of the SCR 220 are known in the art, and can include increasing the temperature of exhaust gas 216 generated by the ICE 26 (e.g., via a particulate filter regeneration procedure), and/or utilizing a heater appurtenant to the exhaust gas treatment system 34 (e.g., an electrically heated catalyst heater disposed within or proximate to the SCR 220 or AGC 218).

Once the SCR 220 is substantially empty of all reductant 246 stored therein, method 300 further comprises maintaining 330 a rich ICE 26 operating condition. A rich ICE 26 operating condition occurs when the mixture of air and fuel combusted within the ICE 26 has an air to fuel mass ratio of about less than about 14.7, less than about 14.6, or less than about 14.5. Under such conditions, the exhaust gas 216 comprises a high NOx content and is communicated to the AGC 218 where the NOx species are converted to NH₃. Without being held to a particular mechanism, NH3 can be generated within the AGC 218 through the catalytic reduction of NOx by H₂, for example as shown by equation (9):

$$NO + \frac{5}{2} {H}_{2} -> {NH}_{3} + {H}_{2} O \qquad ( 9 )$$

Diatomic hydrogen can be generated from diesel exhaust gas, for example via the water-gas shift reaction shown by equation (10):

CO+H₂O→CO₂+H₂ (10)

In some embodiments, the exhaust gas 216 generated during the rich ICE 26 operating condition preferably comprises a high NO:NO₂ ratio. In both a DOC and a LNT, NOx species can be converted to NH3 at temperatures of about 275 to 500, depending on the design features (e.g., catalyst type, catalyst loading) of the particular AGC 218. Accordingly, increasing the temperature 320 of the SCR 220 can additionally comprise increasing the temperature of the AGC 218 in order to effect an AGC 218 temperature suitable for converting NOx species to NH3. The operating conditions of the ICE 26 and the temperature of the AGC 218 are preferably controlled such that substantially all of the NOx species present in the exhaust gas 216 are converted to NH3 within the AGC 218. Because NOx sensors exhibit a cross-sensitivity to NOx and NH3, the upstream NOx sensor 242 the NOx detected within the exhaust gas 216 can be entirely, or at least substantially, attributed to NH3.

Exhaust gas 216 and NH3 generated within the AGC 218 are subsequently communicated through the SCR 220, wherein the generated NH3 is stored. Initially, all, or substantially all, of the NH3 generated within the AGC 218 will be stored, and the downstream NOX sensor 243 will detect no, or substantially no, NOx species. When the amount of successively stored NH3 reaches the reductant 246 storage capacity of the SCR 220, NH3 slip will occur and be observed by the downstream NOx sensor 423. The observed NH3 slip and optionally other exhaust gas treatment system characteristics during the diagnostic period can be utilized to determine 340 a SCR 220 reductant 246 storage capacity. For example, the SCR 220 reductant 246 storage capacity (i.e., the NH3 storage capacity) can be determined by subtracting the integral of the downstream NOx concentration (e.g., as measured by the downstream NOx sensor 243 during the diagnostic period) from the integral of the upstream NOx concentration (e.g., as measured by the upstream NOx sensor 242 during the diagnostic period) to determine mass value for the SCR 220 storage capacity. The mass value can be converted to a mass per volume (e.g., grams per liter) value based on the physical characteristics of the SCR 220 (e.g., the SCR 220 catalyst volume).

Subsequent to determining 340 the SCR 220 reductant 246 storage capacity, method 300 can further optionally comprise implementing 350 a control action based on the determined 340 SCR 220 reductant 246 storage capacity. In some embodiments, a control action will only be implemented if the determined 340 SCR 220 storage capacity is confirmed by a statistically significant plurality of method 300 implementations (e.g., 2, 3, 4, or more than 4 method 300 implementations). In all such embodiments, the target SCR 220 storage capacity can be determined based upon an aging characteristic of the SCR 220, such as elapsed time since installation in exhaust gas treatment system 34 or total operating time.

If the determined 340 SCR 220 reductant 246 storage capacity is below a target capacity, the control action can comprise one or more of activating an alarm, servicing the SCR 220, and updating SCR 220 control logic to reflect a reduced SCR 220 storage capacity. Activating an alarm can comprise activating an audible alarm, illuminating an indicator (e.g., a dashboard indicator), or otherwise alerting a system (e.g., a vehicle connectivity network) or person, for example. Servicing the SCR 220 can comprise repairing the SCR 220 (e.g., cleaning) or replacing the SCR 220, for example. Updating the SCR 220 control logic can comprise updating an SCR 220 chemical model or reductant 246 dosing logic, for example.

If the determined 340 SCR 220 reductant 246 storage capacity is at or above a target capacity, the control action can comprise implementing a non-SCR 220 diagnostic action. Implementing a non-SCR 220 diagnostic action can comprise diagnosing any aspect of the exhaust gas treatment system 34 and/or the ICE 26 which may impact the performance of the SCR 220, such as diagnosing the AGC 218, diagnosing the injector 236, diagnosing one or more aspects of the reductant supply source 234, or diagnosing the upstream NOx sensor 242 and/or the downstream NOx sensor 243, for example. Diagnosing one or more aspects of the reductant supply source 234 can comprise diagnosing an appurtenant level sensor (not shown), or the composition of the reductant 246, for example.

### EXAMPLE 1

A stream of exhaust gas was provided to a DOC at varying temperatures in order to assess the NH3-generating characteristics of the DOC. The DOC had a cumulative platinum and palladium loading of 113 g/ft³. The exhaust gas was generated by combusting an air-fuel mixture with an air:fuel ratio of 14.3 to generate an exhaust gas stream comprising about 12,000 ppm CO, 500 ppm H₂, 2,000 ppm C3 hydrocarbon(s), 190 ppm NO, 1.2 volume % O₂, 13.0 volume % CO₂, and 4 volume % H₂0. The space velocity during the experiment was 70K/hour. FIG. 4 illustrates a graph of the NH3 and NO concentrations of the exhaust gas at the DOC outlet.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An exhaust gas treatment system, comprising:
an internal combustion engine (ICE);
an ammonia-generating catalytic device (AGC) configured to receive exhaust gas generated by the ICE and capable of generating ammonia from rich exhaust gas;
a selective catalytic reduction device (SCR) configured to receive exhaust gas and ammonia generated by the AGC;
an upstream NOx sensor disposed upstream from the SCR;
a downstream NOx sensor disposed downstream from the SCR; and
a controller configured to:
increase the temperature of the SCR to substantially empty all reductant stored within the SCR;
maintain a rich ICE operating condition; and
subsequently determine a SCR reductant storage capacity using the downstream NOx sensor.

2. The exhaust gas treatment system of claim 1, wherein the AGC comprises a diesel oxidation catalyst or a lean NOX trap.

3. The exhaust gas treatment system of claim 1, wherein the AGC comprises a platinum and/or palladium catalyst.

4. The exhaust gas treatment system of claim 1, wherein during the rich ICE operating condition the ICE air to fuel mass ratio is less than about 14.7.

5. The exhaust gas treatment system of claim 1, wherein the controller is configured to increase the temperature of the SCR by increasing the temperature of the exhaust gas generated by the ICE, and/or utilizing a heater appurtenant to the exhaust gas treatment system.

6. The exhaust gas treatment system of claim 1, wherein the controller is further configured to determine unsuitable SCR performance prior to increasing the temperature of the SCR.

7. The exhaust gas treatment system of claim 6, wherein unsuitable performance can comprise unsuitable NOx reduction efficiency, and/or unsuitable NOx slip.

8. The exhaust gas treatment system of claim 1, wherein the controller is further configured to implement a control action based on the determined SCR reductant storage capacity.

9. The exhaust gas treatment system of claim 8, wherein, if the determined SCR reductant storage capacity is below a target capacity, the control action comprises one or more of activating an alarm, servicing the SCR, and updating SCR control logic to reflect a reduced SCR storage capacity.

10. The exhaust gas treatment system of claim 8, wherein, if the determined SCR reductant storage capacity is at or above a target capacity, the control action comprises implementing a non-SCR diagnostic action.

11. A method for diagnosing a selective catalytic reduction device (SCR) of an exhaust gas treatment system, wherein the exhaust gas treatment system comprises an internal combustion engine (ICE), an ammonia-generating catalytic device (AGC) configured to receive exhaust gas generated by the ICE and capable of generating ammonia from rich exhaust gas, the SCR configured to receive exhaust gas and ammonia generated by the AGC, an upstream NOx sensor disposed upstream from the SCR, and a downstream NOx sensor disposed downstream from the SCR, the method comprising:
increasing the temperature of the SCR to substantially empty all reductant stored within the SCR;
during a diagnostic period, maintaining a rich ICE operating condition and communicating the generated exhaust gas to the AGC and the SCR; and
determining a SCR reductant storage capacity based on measurements taken by the downstream NOx sensor during the diagnostic period.

12. The method of claim 11, wherein the AGC comprises a diesel oxidation catalyst or a lean NOX trap.

13. The method of claim 11, wherein the AGC comprises a platinum and/or palladium catalyst.

14. The method of claim 11, wherein during the rich ICE operating condition the ICE air to fuel mass ratio is less than about 14.7.

15. The method of claim 11, wherein the temperature of the SCR is increased by increasing the temperature of the exhaust gas generated by the ICE, and/or utilizing a heater appurtenant to the exhaust gas treatment system.

16. The method of claim 11, further comprising determining unsuitable SCR performance prior to increasing the temperature of the SCR.

17. The method of claim 16, wherein unsuitable performance can comprise unsuitable NOx reduction efficiency, and/or unsuitable NOx slip.

18. The method of claim 11, further comprising implementing a control action based on the determined SCR reductant storage capacity.

19. The method of claim 18, wherein, if the determined SCR reductant storage capacity is below a target capacity, the control action comprises one or more of activating an alarm, servicing the SCR, and updating SCR control logic to reflect a reduced SCR storage capacity.

20. The method of claim 17, wherein, if the determined SCR reductant storage capacity is at or above a target capacity, the control action comprises implementing a non-SCR diagnostic action.
